(19) United States
(12) Patent Application Publication
(10) Pub. No.: US 2014/0360699 A1
(43) Pub. Date: Dec. 11, 2014

(54) VARIABLE GEOMETRY HEAT SINK ASSEMBLY

(71) Applicant: Mide Technology Corporation, Medford, MA (US)

(72) Inventors: Marthinus van Schoor, Medford, MA (US); Steven Thomas, Cambridge, MA (US)

(21) Appl. No.: 13/912,234

(22) Filed: Jun. 7, 2013

(51) Int. Cl. F28F 13/06; B23P 15/26

(52) U.S. Cl. CPC F28F 13/06; B23P 15/26
USPC 165/96; 29/890.03

(57) ABSTRACT

A heat sink assembly and method wherein a base plate is mountable to a heat source and spaced fins on the base plate define flow channels therebetween. Self actuating louvers are configured to increase flow through select channels in response to increased temperatures.

### FIELD OF THE INVENTION

The subject invention relates to heat dissipation devices such as heat sinks.

### BACKGROUND OF THE INVENTION

Heat dissipation devices such as heat sinks are used to cool heat sources such as electronic components, semiconductor chips, and the like. See U.S. Patent Publication No. 2005/0245659 incorporated herein by this reference. In that reference, shape memory alloy material is added to the thermal grease between a heat sink and an electronic device.

In WO 99/04429, also incorporated herein by this reference, the fins of a heat sink are made of shape memory alloy material. When the heat sink reaches the transition temperature of the shape memory alloy material, the fins straighten and convert thermal energy into deformation energy in the process.

In some applications, it would be desirable to vary the heat dissipation characteristics of a heat sink. Known heat sinks do not seem to meet this requirement in an economical way or via a manufacturable method.

### BRIEF SUMMARY OF THE INVENTION

In certain aspects of the invention, a variable geometry heat sink is provided using shape memory alloy louvers which self actuate to vary the heat dissipation characteristics of the heat sink.

One heat sink assembly in accordance with examples of the invention feature a base plate mountable to a heat source and spaced fins on the base plate defining flow channels therebetween. Self actuating louvers are configured to increase flow through select channels in response to increased temperatures. In some designs, the self activating louvers extend from ends of the fins and each louver is made of a shape memory alloy material having a transition temperature below which the louver is more closed and above which the louver is more open. Typically, the transition temperature is less than a critical operating temperature of a device coupled to the heat sink.

In some examples, each channel has an inlet and there is a louver disposed at the inlet. Also, it may be preferred for each louver to be configured to open more in response to increased temperatures of its corresponding channel. In one version, the spaced fins are angled across the base plate.

In another design, there is a cover over the spaced fins and the self actuating louvers are disposed in the cover. In still another design, the self actuating louvers are on top of the spaced fins.

The invention further features a heat sink assembly comprising a base plate mountable to a heat source, spaced fins on the base plate defining flow channels therebetween, and a self actuating louver including shaped memory alloy material extending from an end of select fins and configured to increase flow through select flow channels in response to increased temperatures.

One heat sink assembly includes a base plate mountable to a heat source, spaced fins on the base plate defining flow channels therebetween, a cover over the spaced fins, and self actuating louvers in the cover configured to increase flow through select channels in response to increased temperatures.

An exemplary heat sink assembly may include spaced fins defining flow channels therebetween and self actuating louvers configures to increase flow through select channels in response to increased temperatures, each louver configured to open more in response to increased temperature of its corresponding channel and to close more in response to decreased temperatures of its corresponding channel.

The invention also features a method of manufacturing a heat sink assembly. One method comprises procuring or manufacturing a base plate mountable to a heat source including spaced fins defining flow channels therebetween and adding self actuating louvers configured to increase flow through select channels in response to increased temperatures. The self actuating louver may be assembled to extend from an end of select fins and each louver may be made of a shape alloy material having a transition temperature below which the louver is more closed and above which the louver is more open and a transition temperature less than a critical operating temperature of a device coupled to the heat sink.

In the method, each channel may have an inlet with a louver. One method may include configuring each louver to open more in response to increased temperatures of its corresponding channel, and/or angling the spaced fins across the base plate, and/or adding a cover over the spaced fins and disposing the self actuating louvers in the cover.

One method includes adding self actuating louvers to a heat sink assembly to increase flow in select channels thereof in response to increased temperatures, actuating a louver to open more in response to increased temperatures of its corresponding channel, and actuating a louver to close more in response to decreased temperatures of its corresponding channel.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1A is a schematic three dimensional top view showing an example of a heat sink assembly in accordance with the subject invention with shape memory alloy louvers mostly closed restricting air flow across their respective flow channels;

FIG. 1B is a schematic three dimensional top view similar to FIG. 1A except now two shaped memory alloy louvers have self actuated to a more open position allowing increased air flow across their respective flow channels;

FIG. 2 is a schematic three dimensional top view showing another example of heat sink assembly in accordance with the invention wherein the fins are angled with respect to the extent of the heat sink base plate;

FIG. 3A is a top view showing a simulated temperature plot for heat sink construction in accordance with the example shown in FIG. 2 with angled fins showing three louvers in a more open position and the rest of the louvers in a more closed position;

FIG. 3B is a view similar to FIG. 3A except now all the louvers are in a more closed position since they have not been activated;

FIG. 4A is a heat sink flow velocity plot for the heat sink assembly shown in FIG. 3A in the geometry wherein three louvers have been activated and are thus more fully open;

FIG. 4B is a heat sink velocity plot similar to FIG. 4A except now all the louvers are in a more closed (non-activated) configuration;

FIG. 5A is a bottom view, heat sink surface temperature plot for the base plate of the heat sink assembly shown in FIGS. 3-4 for the configuration where the same three louvers are more open in an activated state;

FIG. 5B is a heat sink surface temperature plot similar to FIG. 5A showing the temperature profile when all the louvers are in a more fully closed position (non-activated);

FIG. 6 is a schematic three dimensional front view showing an example of a heat sink assembly in accordance with another example of the invention; and

FIG. 7 is a schematic three dimensional front view showing still another example of a heat sink assembly in accordance with the invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

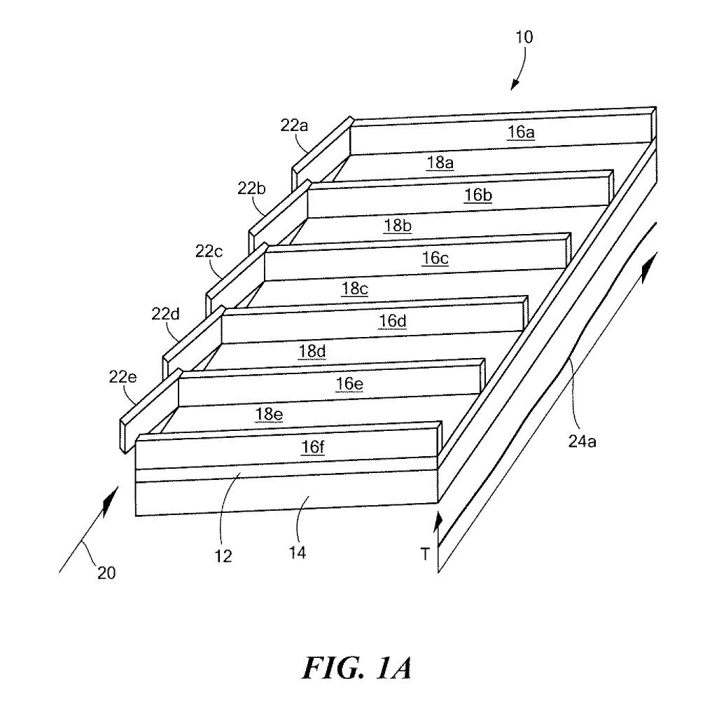

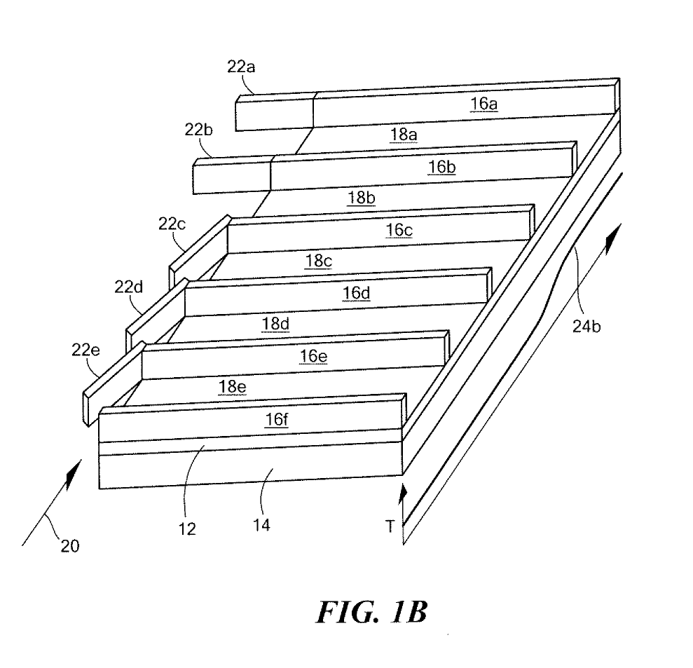

Heat sink assembly 10, FIG. 1, in one preferred example includes substrate or base portion 12 mountable to a heat source such as electronic device 14. Spaced fins 16a-16f are on or otherwise extend upwards or outwards from base plate 12. Base plate 12 and fins 16 may be made of aluminum. The fins define flow channels such as flow channels 18a-18e for a fluid such as air, some other gas, or even a liquid. The predominant flow may be as shown at 20. In this example, self actuating alloy louvers 22a-22e are configured to increase flow through select channels 18a-18e in response to increased temperatures. As shown in this particular embodiment, the louvers extend from the channel inlet ends of fins 16a-16f. As shown in FIG. 1A, the louvers are preferably closed or mostly closed when the temperatures across the extent of base plate 12 are below the transition temperature of the shaped memory alloy material as shown at 24.

In FIG. 1B, however, the temperature at flow channels 18a and 18b has increased as shown at 24b to a temperature above a transition temperature of the material chosen for the louvers and now louvers 22a and 22b more fully open increasing the air flow through or across their respective flow channels 18a and 18b. This increase in temperature could be due, for example, to chips or components of electronic device 14 below channels 18a and 18b heating up. Louvers 22c, 22d, and 22e remain more closed as shown.

Preferably, each louver 22 is made of a two way shape memory alloy material such as Nitinol. See WO 99/04429 incorporated herein by this reference and U.S. Pat. No. 6,689,486 also incorporated herein by this reference. The chosen material typically has a transition temperature below which the louver bends to a more closed position (see FIG. 1A) and above which the louver bends to a more open position (see FIG. 1B). Also, the transition temperature is typically less than the critical operating temperature of the device or devices coupled to the base plate of the heat sink assembly so the louvers open as shown in FIG. 1B and allow more air to flow in the heat sink flow channels before the critical operating temperature of the device is reached.

The hysteresis range for shape memory alloys is defined by the temperatures where the phase transition starts and the phase transition ends. Typically, the difference between these two temperatures is undesirable for shape memory alloy applications (such as actuator applications) since it is normally better for actuation to occur quickly. For this particular application, however, a wide hysteresis range may be preferable since a wide hysteresis range allows the shape memory alloy louvers to gradually deploy and more finely regulate the heat sink fin temperature over a wider range of temperatures.

Additionally, different phase transition regimes can also be used with a single heat sink to tune the performance over a wide temperature range. Components with more stringent heat sink requirements would be positioned under channels controlled by louvers with a lower transition temperature while components that have higher maximum operating temperatures would have channels controlled by louvers with higher transition temperatures.

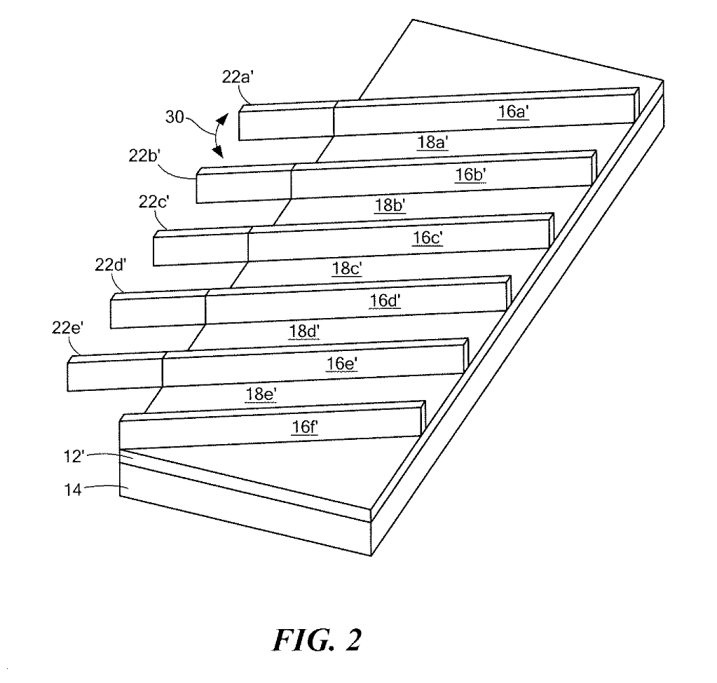

In FIG. 2, fins 16′ are angled across base plate 12′. In this configuration, inclined or angled fins allow for more effective targeting by the self actuating louvers since each heat sink channel is shorter. Additionally, such a fin design has been shown to be more effective in certain geometries than vertically-oriented fins.

Here, a louver 22′ is bonded or welded to the flow inlet ends of select angled or inclined fins and deflects between more open and more closed positions are shown by arrow 30. In this way, flow through select channels is increased or decreased (regulated) in response to temperature changes experienced by the flow channels. In general, a louver opens fully as shown in FIG. 2 as the temperature of its corresponding flow channel reaches or increases above the transition temperature of the material of the louver and the louver closes partially or fully when its corresponding flow channel temperature reaches or goes below the transition temperature of the material of the louver. These shape memory alloy flaps or louvers located at the inlet of the heat sink channels direct air flow resulting in a variable geometry heat sink assembly. The louvers are typically memorized to be more fully open and direct air flow to specific areas of the heat sink allowing for increased air flow when higher temperatures are present.

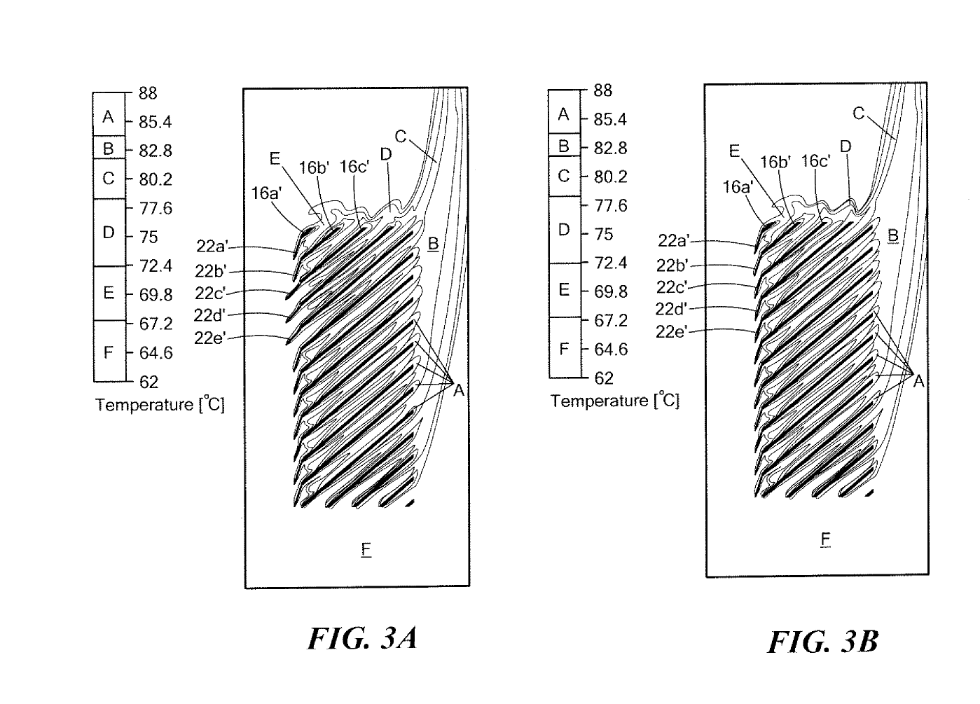

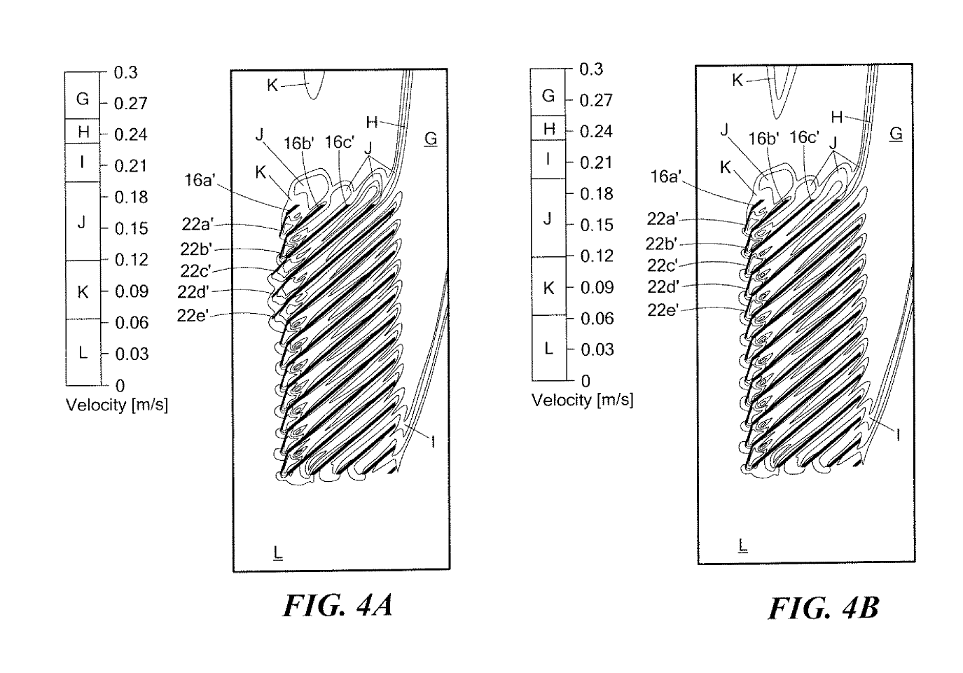

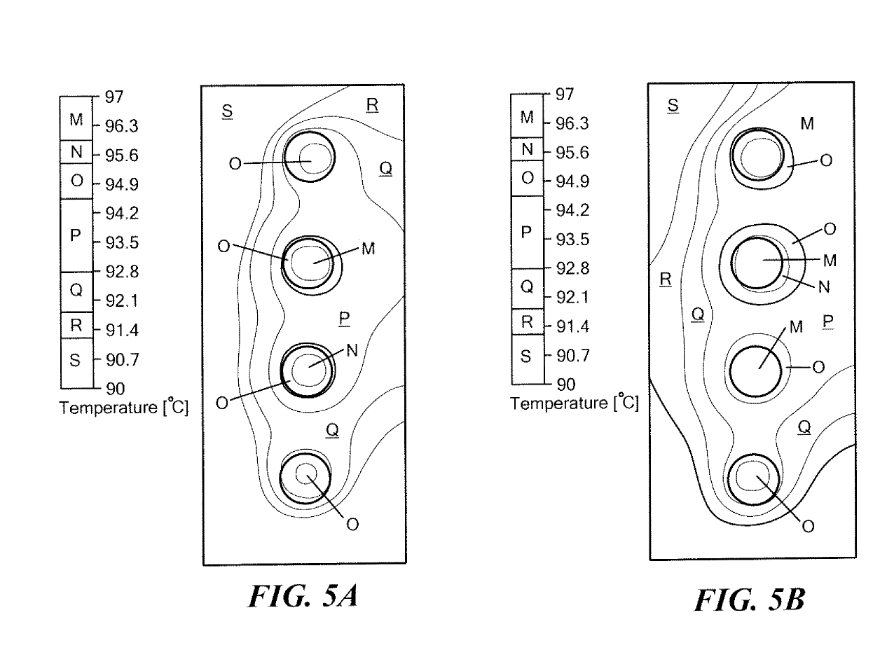

In the simulation shown in FIGS. 3-5, the upper most heat source has been targeted. In the activated state shown in FIG. 2, all of the louvers are identically positioned and are more fully open. The louvers serve as an extension of the heat sink fins allowing for increased air flow and channel air over the selected heat sources. A simulation was conducted using natural convection, although the concepts disclosed herein can be used in systems with forced convection. In the simulation, heat was generated by four identical heat sources on the bottom of the base plate 12′. Heat sink materials were modeled as 3003-0 aluminum alloy. FIG. 3A shows the heat sink temperature when three louvers 22e′, 22d′ and 22e are activated (more fully opened) and the remaining louvers are not activated and are in a more closed position. FIG. 3B shows the same heat sink temperature plot but now all the louvers are in a more closed position. The activated configuration shown in FIG. 3A shows a reduction in air temperature of around 7° C. through the activated channels corresponding to louvers 22c, 22d, and 22e. FIG. 4 illustrates the flow velocity increase due to deployment of the louvers, at approximately a 30% increase over the non activated state shown in FIG. 4B. Perhaps the most important benefit can be seen in the surface temperature plot of the bottom based plate shown in FIGS. 5A and 5B. The target heat source sees an approximate 5% temperature reduction between the activated (FIG. 5A) and non activated (FIG. 5B) configurations.

Again, in FIGS. 3A, 4A, and 5A, louvers 22c′, 22d′, and 22e′ are more fully open and in FIGS. 3B, 4B and 5B these louvers are in a more fully closed position or not activated. It is understood that the geometry of the fins, the selection of all the materials, the configuration of the self actuating louvers, and the like can be optimized for a specific application to achieve even better performance.

The activation temperature can be tailored to specific temperature requirements of electrical components and need not be uniform for all louvers on a given heat sink. Components with more sensitive temperature requirements could be placed underneath channels with SMA louvers that have a lower activation temperature, while electrical components with higher temperature capabilities could have SMA louvers with higher activation temperature. So, In FIG. 1A for example, at temperature 24a, louvers 22a and 22b might open for sensitive components mounted proximate channels 18a and 18b while at the same temperature the louvers 22c-22e remain closed for less sensitive components mounted proximate channels 18c-18e. At a higher temperature, all the louvers may open.

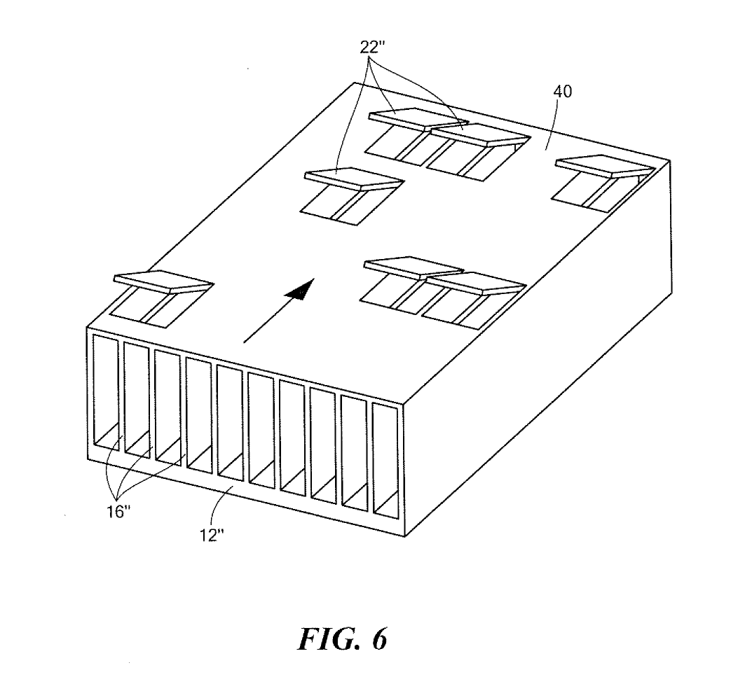

FIG. 6 shows an example for a situation in which louvered flow inlets are not feasible or desirable. In this example, there are still spaced fins 16″ extending upward from based plate 12″ but now cover 40 has been added to the top of fins 16″ and self actuating louvers 22′ are actuatable with respect to cover 40 as shown in order to increase flow through select channels in response to increased temperatures. The remaining louvers integral with cover 40 shown in FIG. 6 are fully closed in the figure.

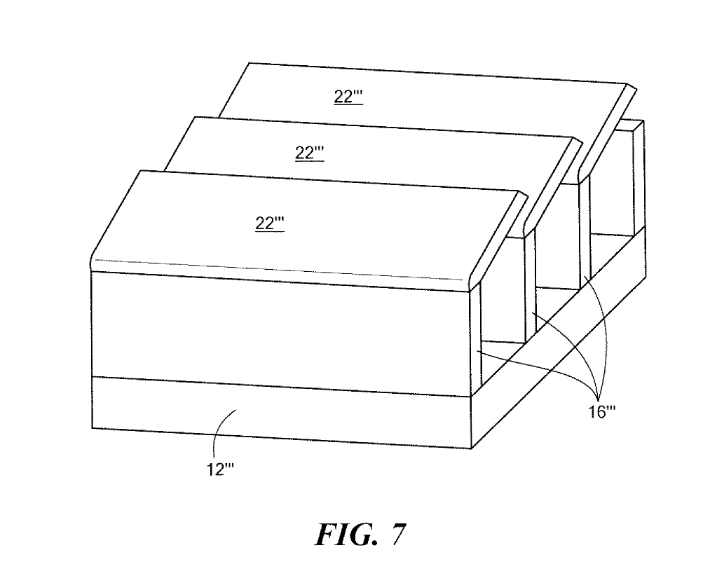

FIG. 7 shows an example where based plate 12′ includes spaced fins 16′ and now the self actuating louvers 22″ are attached to the top portion of the respective fins and actuatable between a closed or almost closed position as shown in FIG. 7 and a more fully opened configuration where louvers 22″ are fully vertical and lie in the same plane as their respective fins.

Thus, although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A heat sink assembly comprising:
a base plate mountable to a heat source;
spaced fins on the base plate defining flow channels therebetween;
self actuating louvers configured to increase flow through select channels in response to increased temperatures.

2. The heat sink assembly of claim I in which the self activating louvers extend from ends of the fins.

3. The heat sink assembly of claim 1 in which each louver is made of a shape memory alloy material.

4. The heat sink assembly of claim 3 in which the shape memory alloy material has a transition temperature below which the louver is more closed and above which the louver is more open.

5. The heat sink assembly of claim 4 in which the transition temperature is less than a critical operating temperature of a device coupled to the heat sink.

6. The heat sink assembly of claim I in which each channel has an inlet and there is a louver disposed at said inlet.

7. The heat sink assembly of claim 6 in which each said louver is configured to open more in response to increased temperatures of its corresponding channel.

8. The heat sink assembly of claim I in which the spaced fins are angled across the base plate.

9. The heat sink assembly of claim 1 further including a cover over the spaced fins and the self actuating louvers are disposed in said cover.

10. The heat sink assembly of claim 1 in which the self actuating louvers are on top of the spaced fins.

11. A heat sink assembly comprising:
a base plate mountable to a heat source;
spaced fins on the base plate defining flow channels therebetween; and
a self actuating louver including shaped memory alloy material extending from an end of select fins and configured to increase flow through select flow channels in response to increased temperatures.

12. A heat sink assembly comprising:
a base plate mountable to a heat source;
spaced fins on the base plate defining flow channels therebetween;
a cover over the spaced fins; and
self actuating louvers in the cover configured to increase flow through select channels in response to increased temperatures.

13. A heat sink assembly comprising:
spaced fins defining flow channels therebetween; and
self actuating louvers configured to increase flow through select channels in response to increased temperatures, each louver configured to open more in response to increased temperature of its corresponding channel and to close more in response to decreased temperatures of its corresponding channel.

14. A method of manufacturing a heat sink assembly, the method comprising:
procuring or manufacturing a base plate mountable to a heat source including spaced fins defining flow channels therebetween; and
adding self actuating louvers configured to increase flow through select channels in response to increased temperatures.

15. The method of claim 14 in which a self actuating louver is assembled to extend from an end of select fins.

16. The method of claim 14 in which each louver is made of a shape alloy material.

17. The method of claim 16 in which the shape memory alloy material has a transition temperature below which the louver is more closed and above which the louver is more open.

18. The method of claim 17 in which the transition temperature is less than a critical operating temperature of a device coupled to the heat sink.

19. The method of claim 14 in which each channel has an inlet and there is a louver disposed at said inlet.

20. The method of claim 19 including configuring each louver to open more in response to increased temperatures of its corresponding channel.

21. The method of claim 14 including angling the spaced fins across the base plate.

22. The method of claim 14 further including adding a cover over the spaced fins and disposing the self actuating louvers in said cover.

23. A heat sink method comprising:
adding self actuating louvers to a heat sink assembly to increase flow in select channels thereof in response to increased temperatures;
actuating a louver to open more in response to increased temperatures of its corresponding channel; and
actuating a louver to close more in response to decreased temperatures of its corresponding channel.
